(19) United States
(12) Patent Application Publication
(10) Pub. No.: US 2014/0265641 A1
(43) Pub. Date: Sep. 18, 2014

(54) ZERO CURRENT SWITCHING WITH A SECONDARY ENERGY STORAGE CAPACITOR IN A SOLAR INVERTER

(71) Applicant: QUALCOMM MEMS TECHNOLOGIES, INC., San Diego, CA (US)

(72) Inventor: Hitoshi Inoue, Yamaguchi (JP)

(73) Assignee: QUALCOMM MEMS Technologies, Inc., San Diego, CA (US)

(21) Appl. No.: 13/831,109

(22) Filed: Mar. 14, 2013

(51) Int. Cl. G05F 1/10

(52) U.S. Cl. CPC G05F 1/10
USPC 307/151

(57) ABSTRACT

This disclosure provides devices and methods for efficiently converting a solar panel DC output to a desired AC or DC output. In one aspect, zero current switching is enabled via a resonant circuit load. In another aspect, switching losses are reduced via an inductor in series with a switch. In another aspect, a more reliable energy storage device may be used.

### TECHNICAL FIELD

This disclosure relates to devices and methods for improving the performance and reliability of solar inverters used in the conversion of the direct current output of a solar panel to power a variety of loads.

### BACKGROUND

Over the last decade, electrical power generation has increasingly come in the form of solar power generators deployed in both residential and commercial settings. This trend is driven by a number of factors, including technical innovations leading to the falling costs and increased efficiency of solar power as well as environmental concerns like the reduction of carbon dioxide emissions. In recent years, researchers have made many technical innovations at the photovoltaic (PV) cell level. The PV cell is the device that converts light (e.g., from the sun) into electrical energy, typically in the form of a direct current (DC) output. The DC output may vary based on the incident angle and intensity of the light source at the active surface of the PV cell. While adequate for certain low voltage DC applications, other applications require the DC output to be converted into a high-voltage, high-frequency alternating current (AC) output. These other applications include powering devices normally plugged into an electric grid and even selling the generated power back to the electric provider.

A solar inverter is used to convert the low voltage DC output from the PV cell into an AC output with a desired amplitude, frequency, and phase. Most solar inverters use a technique known as pulse width modulation (PWM) to convert the DC output into an AC output. PWM has several disadvantages. Traditionally, PWM is used to control the switches in an inverter. Because the switches may be turned on or off irrespective of the state of switch conduction, this so called hard switching generates high current spikes in the inverter increasing component stress and power loss dissipated in the switches. As the frequency of the modulation increases, so does switching power loss.

Most solar inverters also include one or more electrolytic capacitors. Electrolytic capacitors are typically included near the PV cell output as the panel's instant current capacity is likely insufficient for the inverter to generate a peak power AC cycle. The electrolytic capacitor acts an energy storage device, enabling peak power AC. While important for energy storage, electrolytic capacitors are prone to failure. One reason for this is degradation of the electrolyte solution. Elevated temperatures cause the electrolyte in the capacitor to degrade. As expected, these capacitors may be subjected to elevated temperatures in locations commonly associated with solar installations (e.g., the top of a roof). Further, elevated temperatures also increase the series resistance of the electrolytic capacitors, which increases the internal temperature of the capacitor, exacerbating the problem and accelerating the aging process.

With the increased deployment of solar power generation, there is a need for improvements to the reliability and efficiency of solar power inverters.

### SUMMARY

The systems, methods and devices of the disclosure each have several innovative aspects, no single one of which is solely responsible for the desirable attributes disclosed herein.

One innovative aspect of the subject matter described in this disclosure can be implemented in a solar panel generation apparatus. The apparatus may include a solar panel having an output; a first stage coupled to the solar panel output and configured to convert the solar panel output into a first stage AC output, and a second stage having an input coupled to the AC output and configured to convert the AC output into a DC output having a higher voltage than the solar panel output, the second stage having a resonant LC circuit configured to reduce power loss in the first stage. In some of these implementations, no electrolytic energy storage capacitor is connected across the input of the first stage.

In another implementation, a method of converting solar energy includes generating a DC output via a photovoltaic cell, converting the DC output into a high frequency AC output via a high frequency conversion stage, loading the high frequency conversion stage with a resonant circuit to limit the high frequency alternating current to a substantially sinusoidal waveform, rectifying the high frequency AC output to a high voltage DC output, and converting the high voltage DC output into a low frequency AC output via a DC to AC converter.

In another implementation, a solar power generation apparatus includes means for producing a DC output in response to incident light, means for converting the DC output into a high frequency AC output, means for converting the high frequency AC output into a DC output having a higher voltage than the output of the producing means, and means for loading the means for converting the DC output to shape the current waveform of the high frequency AC output.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a block diagram of an exemplary solar power system.

FIG. 2 shows a circuit schematic of an exemplary solar inverter.

FIGS. 3A-3C show circuit schematics of exemplary DC to high frequency AC inverters.

FIG. 4 shows a circuit schematic of an exemplary secondary resonant load and filter to convert a high frequency AC signal into a high voltage DC signal.

FIG. 5A shows a circuit schematic of the high frequency conversion stage connected to a resonant stage.

FIG. 5B shows two waveforms depicting zero current switching as present in the circuit shown in FIG. 5A.

FIG. 6 shows two waveforms depicting how the DC to high frequency AC inverter may be controlled to adapt to varying DC input levels.

FIG. 7 shows a circuit schematic of an exemplary DC to AC circuit used to convert the DC output of the circuit shown in FIG. 4 to a desired frequency.

FIG. 8A shows exemplary waveforms of the pulse frequency modulation signals used to control the switches depicted in FIG. 7.

FIG. 8B depicts a simplified diagram of a control loop that may be used to generate the pulse frequency modulation signals shown in FIG. 8A.

FIG. 9 shows two waveforms depicting the current through switch Tr1 with and without inductor L1.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways.

The multi-stage solar inverter described herein may be used to convert the DC output of a solar panel into a desired voltage DC output or an AC output matched to a desired voltage, frequency, and phase. The inverter disclosed herein has improvements to both efficiency and reliability. One aspect of improving efficiency involves minimizing switching losses. A resonant circuit load at the output of a high frequency conversion stage enables zero current switching by limiting the source current to a sinusoidal current waveform. With zero current switching, switching losses may be theoretically reduced to zero. With the sinusoidal current waveform, switching losses may be reduced at both the rising and falling edges of the current. Further, the sinusoidal current waveform reduces power loss in the rectifier diodes on the secondary side of a transformer and in the transformer itself. Transformer losses are reduced by eliminating harmonic magnetic field components at frequencies higher than the frequency of the fundamental harmonic. This effect reduces core hysteresis loss, eddy current and skin effect losses on the magnet wires, and magnetic field loss due to the proximity of the magnet wires. One aspect of improving reliability involves using an energy storage capacitor on the secondary side of a transformer rather than on the primary side. This reduces the required capacitance, enabling the selection of alternate capacitor technologies with higher reliability than electrolytic capacitors. As measured in an experimental unit of the disclosed inverter, the efficiency of the high frequency DC to AC conversion stage through the secondary rectifiers and blocking diode was measured at over 98.5%. Including a DC to AC converter for AC output, efficiencies of up to 96.82% were measured across a power range of 170 to 540 watts.

FIG. 1 shows a block diagram of an exemplary embodiment of a solar power system that may include features described herein. A solar panel 10 converts light into a direct current (DC) output. A high frequency conversion stage 20 converts the DC output from the solar panel 10 to a high-frequency AC output. Each switch in the high frequency conversion stage 20 is switched between an ‘ON’ state and an ‘OFF’ state by a control circuit 90 when zero current is flowing through the switch, thus reducing switching losses. The switches in the high frequency conversion stage 20 may be controlled via pulse frequency modulation. The high frequency conversion stage 20 may comprise a center tap circuit, a half-bridge circuit, or a full-bridge circuit, depending on the requirements of the particular application. The high frequency conversion stage 20 may be coupled to a primary winding of a transformer 30. The transformer 30 may be included to isolate the high frequency conversion stage 20 from the rest of the circuitry in the system. The transformer 30 may further step up the high frequency output voltage to a higher voltage, depending on the turns ratio between the primary and secondary windings. The rectifiers, resonant components, filter block 40 (hereinafter “resonant stage 40”) is coupled to the secondary winding of the transformer 30. The resonant stage 40 has components to rectify the high frequency AC output, may step up the voltage of the transformer 30, and sets a resonant frequency of the stage. The resonance of resonant stage 40 controls the current flow from the high frequency conversion stage 20, enabling zero current switching. The storage capacitor, blocking diode block 50 (hereinafter “storage stage 50”) is coupled to the DC output of the resonant stage 40 to store energy for subsequent stages. The DC-AC converter 60 converts the stored energy into an AC output. The switches in the DC-AC converter 60 may be controlled via pulse frequency modulation. The filter & resonant components block 70 (hereinafter “filter stage 70”) removes unwanted switching noise from the AC output of the DC-AC converter 60 and other interference before coupling the AC output to a load 80. A control circuit 90 may provide the timing for the switches in the high frequency conversion stage 20.

FIG. 2 shows a circuit schematic of an exemplary solar inverter configured to convert the DC output of a solar panel into an AC output for the load 80. The various stages depicted in FIG. 2 and alternative embodiments are described below.

### A. High Frequency Conversion Stage

FIGS. 3A-3C show circuit schematics of exemplary DC to high frequency AC inverters that may be used in the high frequency conversion stage 20. In each figure, the DC bus input terminals are coupled to the solar panel DC output. FIG. 3A depicts a half bridge inverter. FIG. 3B depicts a full bridge inverter. FIG. 3C depicts a center tapped load inverter.

Because the circuit depicted in FIG. 3B is referenced in the descriptions below, a brief overview of its operation is provided. Four switches arranged in an H-bridge form the basic configuration of the inverter. The load is connected across the middle nodes of the two series switch legs. To obtain current in one direction, a controller (e.g., control circuit 90) may switch the upper left switch ‘ON’ via gate G1 and the lower right switch ‘ON’ via gate G4, with the other two switches ‘OFF.’ To obtain current flow in the opposite direction, the controller may switch the upper right switch ‘ON’ via gate G3 and the lower left switch ‘ON’ via gate G2. A capacitor C_{c} is included in series with the load to avoid shorting the two voltage rails. A filter/decoupling capacitor C_{f} may be included physically close to the switches to reduce switching noise on the DC bus.

Depending on the output requirements of the high frequency conversion stage 20, any of the three inverters depicted in FIGS. 3A-3C may be used. Of course, other inverter configurations which convert the DC output of the solar panel into a high frequency AC output may also be used.

### B. Transformer

The transformer 30 isolates the high frequency conversion stage 20 from the rest of the circuit, including the DC-AC converter 60 (see FIG. 2), likely operating at a different frequency. Transformer 30 is suitable for operation at the frequency of the AC signal output from the high frequency conversion stage 30. The transformer may also step up the voltage output from the high frequency conversion stage by increasing the turns ratio of the secondary winding relative to the primary winding.

### C. Resonant Stage

FIG. 4 shows a circuit schematic of an exemplary embodiment secondary resonant load and filter to convert a high frequency AC into a high voltage DC. This embodiment may be used in resonant stage 40. One end of the secondary winding of transformer 30 is connected to one end of inductor Lᵣ. The other end of inductor Lᵣ is connected to the node between two series capacitors, Cᵣ₁ and Cᵣ₂. The anode of a diode D₁ is connected to the other end of the secondary winding and the cathode to the end of capacitor Cᵣ₁ the connection to Lᵣ. The anode of a diode D2 is connected to end of capacitor Cᵣ₂ opposite the connection to Lᵣ and the cathode to the node between the secondary winding and the cathode of D₁. If inductor Lr is treated as a short, this circuit configuration acts as a voltage doubler to step up the voltage of the AC output received from the transformer 30. During operation, both capacitors Cᵣ₁ and Cᵣ₂ are charged and prevented from discharging by the diodes D₁, D₂. As a result, the total voltage seen across the capacitors will be approximately double the peak voltage across the secondary winding of transformer 30.

By including inductor Lᵣ in the voltage doubler, the shape of the current waveform output from the power source (e.g., high frequency conversion stage 20) may be controlled. This is due to the series resonant circuit created by inductor Lᵣ and either capacitor Cᵣ₁ or capacitor Cᵣ₂, depending on the polarity of the voltage input. When the anode voltage of diode D₁ is high relative to the voltage at the end of the secondary winding connected to inductor Lᵣ (the “positive half cycle”), the inductor Lᵣ, any leakage inductance Lₜ from transformer 30, and capacitor Cᵣ₁ form a series resonant circuit. When the anode voltage of diode D₁ is low relative to the voltage at the end of the secondary winding connected to inductor Lᵣ (the “negative half cycle”), inductor Lᵣ, any leakage inductance Lᵣ from transformer 30, and capacitor Cᵣ₂ form a series resonant circuit. The resonant frequency fᵣₑₛ of the series resonant circuit is given by

$${f}_{res} = \frac{1}{2 π \sqrt{( {L}_{r} + {L}_{t} ) ( C )}}$$

where C is either Cᵣ₁ or Cᵣ₂ (depending on the relative anode voltage of diode D1). The associated period Tᵣ of the resonant circuit is thus Tᵣ=1/fᵣₑₛ. If the inductances and capacitances in the series resonant circuit are properly selected, the current waveform output from the power source (e.g., high frequency conversion stage 20) will be sinusoidal. Note that the leakage inductance Lₜ of transformer 30 may eliminate the need for the discrete inductor Lᵣ. However, the range of resonant frequencies would be comparatively limited based on the range of operating frequencies for the inverter and capacitance in the selected capacitors Cᵣ₁, Cᵣ₂.

An inductor L_{f} may be included as a choke/low pass line filter on the output of the resonant stage 40.

FIG. 5A shows a circuit schematic of the high frequency conversion stage connected to a resonant stage. In this embodiment, the full-bridge inverter of FIG. 3B serves as the high frequency conversion stage 20 while the secondary resonant load and filter shown in FIG. 4 serves as the resonant stage 40. With this embodiment, if a control circuit 90 (see FIG. 1) sends properly timed control signals to the high frequency conversion stage 20, the full-bridge inverter may switch between a positive half cycle and a negative half cycle while essentially zero current is passing through the switches.

In this circuit configuration the reflected impedance of the load seen by the high frequency conversion stage 20 is the impedance of the resonant stage 40, adjusted for the turns ratio in the transformer 30. Like any series LC circuit, when subjected to a step input the current through the inductor is initially zero. The current increases to a peak current, corresponding to zero voltage across the capacitor. The peak current may vary based on external conditions such as the load impedance or operating voltage, but the resonant period Tᵣ remains constant. The current then decreases toward zero as the voltage across the capacitor increases to a peak voltage. As already mentioned, during the positive half cycle, the diode D₁ blocks any return current to the LC circuit from capacitor Cᵣ₁. Similarly, during the negative half cycle, the diode D₂ blocks any return current from capacitor Cᵣ₂. In this manner the current from the power source (e.g., the high frequency conversion stage 20) has a half sinusoid waveform at the resonant frequency of the LC circuit, fᵣₑₛ.

To take advantage of this circuit configuration, a controller (e.g., control circuit 90) may control the timing of the inverter switching relative to frequency fᵣₑₛ so the inverter switches little longer time than the resonating time period of Tr to switch at zero-current. FIG. 5B shows two waveforms illustrating the zero current switching enabled by the embodiment shown in FIG. 5A. The top waveform depicts the current I_{d} flowing through switch 202, the direction as indicated in FIG. 5A. The bottom waveform depicts the voltage V_{d} across switch 202, the sign also indicated in FIG. 5A. Initially, the controller has turned switch 202 ‘OFF’ via gate G3, indicated by the high drain voltage at the left of the waveform. When controller turns switch 202 ‘ON’, the current in the top waveform flowing through the switch is sinusoidal due to the resonant load of the resonant stage 40, discussed above. After the current peaks and again reaches zero, the controller turns switch 202 into an ‘OFF’ state. The same on-off control applies to the control of switches 201, 203, and 204, adjusted based on switch position in the H-bridge. Because switching power loss in an inverter switch is the product of the drain to source voltage and the drain current, switching at or near zero current minimizes or eliminates switching power loss. During this switching period, any remaining loss is due to the conduction loss through the switch, which is the product of drain current I_{d} and drain saturation voltage of V. However the conduction losses may be negligible as the saturation voltage Vₛ of the switches, e.g., low voltage FETs, may be very low.

With continued reference to FIG. 5B, during the periods where the drain current I_{d} is zero and the drain to source voltage V_{d} is high, switches 204, 203 may be active allowing current to flow in the opposite direction through the load. The drain current and drain to source voltage waveforms of switches 203, 204 would be similar to those depicted in FIG. 5B, though shifted by 180 degrees.

FIG. 6 shows two waveforms depicting how the DC to high frequency AC inverter may be controlled to adapt to varying DC output levels. As previously mentioned, the DC output of a solar panel may vary based on the incident angle and intensity of the light source at the active surface of the PV cell. With the DC bus voltage at the input to the high frequency conversion stage 20 (see FIG. 1 for reference numerals discussed with FIG. 6) varying, the stepped up voltage of the DC output from the resonant stage 40/storage stage 50 may vary. Further, changes in the load 80 may cause variation in the DC output from the storage stage 50, discussed below. To account for these variations, a controller (e.g., control circuit 90) may use pulse frequency modulation to vary the amount of time that elapses between consecutive conduction periods of the switches in the high frequency conversion stage 20. That is, adjusting how frequently the controller turns each switch ‘ON’. Note that the duration that the current flows through a switch is determined by the resonant frequency fᵣₑₛ of the half sinusoid waveform. One or more voltage sensors may be attached to the DC output of the solar panel 10 and/or the DC output of the storage stage 50. The controller may monitor the sensor(s) and, via a control loop, increase the lapsed time between pulses in response to a high voltage on either DC bus or decrease the lapsed time between pulses in response to a low voltage on either DC bus, respectively increasing or decreasing the time averaged voltage on the bus.

### D. Storage Stage

Referring back to FIG. 4 or 5, the storage stage 50 stores energy for subsequent stages. A storage capacitor Cₑ is selected to store enough energy to power a half cycle of the AC output generated by DC-AC converter 60 at the desired frequency (e.g., grid line power of 50/60 Hz). Because the voltage output from the resonant stage 40 is stepped up relative to the voltage at the output of the solar panel 10, less capacitance is required to storage the same amount of energy. This is because the amount of energy stored in a capacitor may be expressed as E=½CV², where C is the capacitance of the capacitor and V is the voltage across the capacitor. Thus, if the voltage is stepped up by a factor of 8, the capacitance necessary to store the same amount of energy drops by a factor of 64. By reducing the capacitance requirement, other types of capacitors may be used such as film capacitors that have much greater reliability than electrolytic capacitors. One such film capacitor is a metalized polypropylene capacitor. By including capacitor Cₑ, a relatively high capacitance electrolytic capacitor can be omitted at the output of the solar panel 10 as indicated in FIG. 4, improving the reliability of the solar inverter.

A blocking diode D_{b} may be included to isolate the subsequent AC stages from the DC output generated by transformer 30 and resonant stage 40, and to minimize any reactive AC current produced by downstream loading.

Some applications may require a DC output. In this case, Cₑ may be selected to operate as a storage capacitor/low pass filter. Other applications requiring an AC output may include one or more of the following stages.

### E. DC-AC Converter

FIG. 7 shows a circuit schematic of an exemplary DC to AC circuit used to convert the DC output of the circuit shown in FIG. 4 to a desired frequency to power a load 80. This embodiment of the DC-AC converter 60 includes switches, here FETs Tᵣ₁, Tᵣ₂, Tᵣ₃, and Tᵣ₄. Arranged in an H-bridge, the switches are controlled by a controller (e.g., controller circuit 90) to produce an AC output from the DC output of the storage stage 50. The controller may control the switches via pulse width modulation (PWM). As the active current path of the H-bridge changes depending on the positive or negative half cycle of the desired AC output signal, the resulting operation of each current path acts like a back converter.

FIG. 8A shows exemplary waveforms of the pulse frequency modulation signals used to control the switches shown in FIG. 7. In this embodiment, the desired output frequency is 50 or 60 Hz, indicated in the top waveform labeled Reference 50/60 Hz. The controller preferably matches the AC output of the DC-AC converter to this reference signal. The reference signal may be generated locally or based on an external signal source (e.g., an electric grid). During the positive half cycle of the reference signal, the controller turns Tᵣ₂ ‘ON’ via signal Pₐ. With Tᵣ₂ ‘ON’, the controller modulates the signal Dₐ to create a pulse train controlling the conduction period of Tᵣ₃. As indicated in the waveform labeled Dₐ, the pulse width increases or decreases as the voltage of the reference signal increases or decreases, respectively. This produces the positive half cycle of the desired AC output. This process repeats for the negative half cycle of the reference signal, the controller instead turning Tᵣ₄ ‘ON’ via signal P_{b}. This time modulating signal D_{b} controlling Tᵣ₁, this reverses the direction of current flow through L_{f}. This produces the negative half cycle of the desired AC output. By sequentially generating the positive and negative half cycles, the resulting AC output is the sinusoidal time averaged output (between inductor Lf and capacitor Cf2) at the reference signal voltage, frequency, and phase.

FIG. 8B depicts a simplified diagram of a control loop that may be used to generate the pulse frequency modulation signals Dₐ and D_{b} shown in FIG. 8A. The reference signal and the AC output of the DC-AC converter 60 are connected to an error amplifier. The PWM modulator & gating block (e.g., control circuit 90) may receive the output of the error amplifier and dynamically adjust the pulse train signals Dₐ and D_{b} to correct for any errors in amplitude (and thus frequency and phase). By operating at a much higher frequency than the reference signal frequency, the AC output of the DC-AC converter 60 remains matched to the reference signal.

Unlike the zero current switching in the high frequency conversion stage 20, the pulse width modulation in the DC-AC converter 60 forces switching during potentially non-zero current. Because Tᵣ₂ and Tᵣ₄ switch relatively infrequently compared to switches Tᵣ₁ and Tᵣ₃, switching power loss is primarily due to the switching of Tᵣ₁ and Tᵣ₃. To reduce the amount of switching losses, inductors L₁ and L₂ are included in series with the switches in the two legs of the H-bridge. Without inductors L₁ and L₂, switching losses are increased and efficiency of the solar inverter is reduced. To illustrate the operation of these inductors, FIG. 9 shows two waveforms depicting the current through switch Tᵣ₁ with and without inductor L₁. When the upper MOSFET of Tᵣ₁ is switched ‘ON’, there is a short circuit current flows through a lower MOSFET if inductor L₁ is not included, resulting in the current transient shown in the upper waveform of FIG. 9. This short circuit current is caused by a Drain-Source capacitor of the lower MOSFET. Because the dumping diode Dₚ in parallel with inductor L₁ is a low current, low voltage, low recovery time diode, the diode loss of this recovery time is negligible. The recovery time of Dₚ may be very short, occurring in less than 100 nanoseconds. By including inductors L₁ and L₂, the switching power losses in switches Tᵣ₁ and Tᵣ₃ may be significantly reduced.

### F. Filter Stage

The filter stage 70 may include common-mode choke, a capacitor, and a parallel resonant circuit. With reference to FIG. 2, the parallel resonant circuit includes inductor Lᵣ₃ and capacitor Cᵣ₃. By selecting the inductor and capacitor such that the resonant circuit has a sharp impedance curve at the operating frequency of the DC-AC converter 60, the fundamental switching frequency of the PWM is effectively filtered by this parallel impedance circuit.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A solar power generation apparatus comprising:
a solar panel having an output;
a first stage coupled to the solar panel output and configured to convert the solar panel output into a first stage AC output; and
a second stage having an input coupled to the AC output and configured to convert the AC output into a DC output having a higher voltage than the solar panel output, the second stage having a resonant LC circuit configured to reduce power loss in the first stage.

2. The solar power generation apparatus of claim 1 wherein no electrolytic energy storage capacitor is connected across the input of the first stage.

3. The solar power generation apparatus of claim 2 wherein the second stage includes a thin film energy storage capacitor connected across the DC output.

4. The solar power generation apparatus of claim 1 further including a transformer coupling the first stage to the second stage, the transformer configured to increase a voltage of the first stage AC output.

5. The solar power generation apparatus of claim 4 wherein the first stage includes a plurality of switches having reduced power dissipation when coupled to the second stage having the resonant LC circuit.

6. The solar power generation apparatus of claim 5 further including a controller configured to control the plurality of switches based at least in part on a resonant frequency of the LC circuit.

7. The solar power generation apparatus of claim 6 wherein the controller controls at least one switch of the plurality of switches by pulse frequency modulation.

8. The solar power generation apparatus of claim 1 further including a third stage coupled to the DC output and configured to convert the DC output into a third stage AC output having a frequency lower than a frequency of the first stage AC output.

9. The solar power generation apparatus of claim 8 wherein the third stage includes a DC to AC converter, the DC to AC converter including an H-bridge that includes a plurality of switches.

10. The solar power generation apparatus of claim 9 wherein the H-bridge further includes an inductor configured to reduce power loss in a switch of the plurality of switches.

11. The solar power generation apparatus of claim 10 further including a controller configured to control at least one switch of the plurality of switches by pulse width modulation.

12. The solar power generation apparatus of claim 10 wherein the H-bridge may be switched between two buck converter configurations based at least in part on the voltage of the third stage AC output.

13. The solar power generation apparatus of claim 11 wherein the two buck converter configurations may further be switched based at least in part on a reference signal.

14. A method of converting solar energy comprising:
generating a DC output via a photovoltaic cell;
converting the DC output into a high frequency AC output via a high frequency conversion stage;
loading the high frequency conversion stage with a resonant circuit to limit the high frequency alternating current to a substantially sinusoidal waveform;
rectifying the high frequency AC output to a high voltage DC output; and
converting the high voltage DC output into a low frequency AC output via a DC to AC converter.

15. The method of converting solar energy of claim 14 further including switching the high frequency conversion stage when the high frequency current is approximately zero.

16. The method of converting solar energy of claim 14 further including limiting a switching transient current in the DC to AC converter.

17. A solar power generation apparatus comprising:
means for producing a DC output in response to incident light;
means for converting the DC output into a high frequency AC output;
means for converting the high frequency AC output into a DC output having a higher voltage than the output of the producing means; and
means for loading the means for converting the DC output to shape the current waveform of the high frequency AC output.

18. The solar power generation apparatus of claim 17, wherein the means for loading includes a resonant circuit load in the means for converting the high frequency AC output into a DC output.

19. The solar power generation apparatus of claim 18, wherein the resonant circuit load includes an inductor.

20. The solar power generation apparatus of claim 17, further including means for converting the DC output into a 50 or 60 Hz AC output.

21. The solar power generation apparatus of claim 20, further including means for reducing power loss in switches included as part of the means for converting the DC output into a 50 or 60 Hz AC output.

22. The solar power generation apparatus of claim 21, wherein the means for reducing power loss in switches included as part of the means for converting the DC output into a 50 or 60 Hz AC output includes an inductor.
